(19) United States
(12) Patent Application Publication
(10) Pub. No.: US 2023/0399010 A1
(43) Pub. Date: Dec. 14, 2023

(54) ENVIRONMENTAL STATE DETECTION BY OBSERVING ROAD VEHICLE BEHAVIORS

(71) Applicant: GM Global Technology Operations LLC, Detroit, MI (US)

(72) Inventors: Rasoul Salehi, Ann Arbor, MI (US); Ofer Saraf, Herzliya (IL); Wen-Chiao Lin, Rochester Hills, MI (US)

(21) Appl. No.: 17/836,429

(22) Filed: Jun. 9, 2022

(51) Int. Cl. B60W 60/00; B60W 40/04; B60W 40/06

(52) U.S. Cl. CPC B60W 60/001; B60W 40/04; B60W 40/06; B60W 2554/4046

(57) ABSTRACT

A vehicle and a system and method for operating the vehicle. The system includes a sensor and a processor. The sensor is configured to obtain raw data of a road actor in an environment. The processor is configured to determine a current behavior of the road actor from the raw data, wherein the current behavior is in response to an environmental state, determine the environmental state based on the current behavior of the road actor, plan a driving policy for the vehicle based on the environmental state, and actuate a movement of the vehicle according to the driving policy.

### INTRODUCTION

The subject disclosure relates to operation of an autonomous vehicle and, in particular, to a system and method for predicting an environmental state or road condition based on the behavior of road actors with respect to the environmental state or road condition.

An autonomous vehicle navigates through its environment by detecting objects in the environment and planning its trajectory to avoid the objects. Such operation focuses on what is immediately detectable by the autonomous vehicle. However, some road conditions are outside of the range of detection or awareness of the vehicle, such as construction down the road, a stalled vehicle, an inactive traffic light, etc. Thus, the autonomous vehicle cannot plan its trajectory for these road conditions. These obstacles nonetheless cause the vehicle, as well as other road actors, to change their behavior from what one normally expects. Accordingly, it is desirable to be able to predict the presence of a degraded environmental state based on the behavior of the other road actors.

### SUMMARY

In one exemplary embodiment, a method of operating a vehicle is disclosed. A current behavior of a road actor in response to an environmental state is detected. The environmental state is determined based on the current behavior of the road actor. driving policy for the vehicle is planned based on the environmental state. A movement of the vehicle is actuated according to the driving policy.

In addition to one or more of the features described herein, the environmental state further includes at least one of an unknown road condition, road construction, a traffic signal malfunction, a stalled vehicle, an obstruction in the road, a weakly controlled or uncontrolled road intersection, and a newly changed road condition. The method further includes obtaining raw data of the road actor, determining a feature for the road actor from the raw data, and determining the current behavior from the feature. The feature of the road actor is at least one of a deceleration, an acceleration, a stopped motion, an initiated motion, a deviation from a lane, and a turn maneuver. The method further includes determining the behavior from a location of the feature within at least one of a temporal and a spatial sequence. The method further includes determining the environmental state using at least one of a Bayesian inference algorithm and a tree diagram. The method further includes creating a model for vehicle behavior, identifying a parameter of the model for an expected behavior of the road actor under a normal environmental state, and detecting a difference between the current behavior and the expected behavior to determine the environmental state from a comparison of the parameter of the model to the parameter for the current behavior.

In another exemplary embodiment, a system for navigating an autonomous vehicle is disclosed. The system includes a sensor and a processor. The sensor is configured to obtain raw data of a road actor in an environment. The processor is configured to determine a current behavior of the road actor from the raw data, wherein the current behavior is in response to an environmental state, determine the environmental state based on the current behavior of the road actor, plan a driving policy for the vehicle based on the environmental state, and actuate a movement of the vehicle according to the driving policy.

In addition to one or more of the features described herein, the environmental state further includes at least one of a road condition, road construction, a traffic signal malfunction, a stalled vehicle, an obstruction in the road, a weakly controlled or uncontrolled road intersection, and a newly changed road condition. The processor is further configured to determine a feature for the road actor from the raw data and determine the current behavior from the feature. The feature of the road actor is at least one of a deceleration, an acceleration, a stopped motion, an initiated motion, a deviation from a lane, and a turn maneuver. The processor is further configured to determine the behavior from a location of the feature within at least one of a temporal and a spatial sequence. The processor is further configured to determine the environmental state using at least one of a Bayesian inference algorithm and a tree diagram. The processor is further configured to create a model for vehicle behavior, identify a parameter of the model for an expected behavior of the road actor under a normal environmental state, and detect a difference between the current behavior and the expected behavior to determine the environmental state from a comparison of the parameter of the model to the parameter for the current behavior.

In yet another exemplary embodiment, a vehicle is disclosed. The vehicle includes a sensor and a processor. The sensor is configured to obtain raw data of a road actor in an environment. The processor is configured to determine a current behavior of the road actor from the raw data, wherein the current behavior is in response to an environmental state, determine the environmental state based on the current behavior of the road actor, plan a driving policy for the vehicle based on the environmental state, and actuate a movement of the vehicle according to the driving policy.

In addition to one or more of the features described herein, the environmental state further includes at least one of a road condition, road construction, a traffic signal malfunction, a stalled vehicle, an obstruction in the road, a weakly controlled or uncontrolled road intersection, and a newly changed road condition. The processor is further configured to determine a feature for the road actor from the raw data and determine the current behavior from the feature. The processor is further configured to determine the behavior from a location of the feature within at least one of a temporal sequence and a spatial sequence. The processor is further configured to determine the environmental state using at least one of a Bayesian inference algorithm and a tree diagram. The processor is further configured to create a model for vehicle behavior, identify a parameter of the model for an expected behavior of the road actor under a normal environmental state, and detect a difference between the current behavior and the expected behavior to determine the environmental state from a comparison of the parameter of the model to the parameter for the current behavior.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an autonomous vehicle, in accordance with an exemplary embodiment;

FIG. 2 is a diagram illustrating a process by which the autonomous vehicle can determine a degraded environmental state based on the behavior of other road actors;

FIG. 3 shows a schematic diagram illustrating different applications for the detected road states;

FIG. 4 shows a flowchart of a method for predicting an environmental state from the behavior or road actions;

FIG. 5 shows a flowchart illustrating the preprocessing steps of the flowchart of FIG. 4;

FIG. 6 shows a flowchart illustrating a step of the flowchart of FIG. 4;

FIG. 7 is a diagram of an illustrative scenario in which an intersection includes a traffic light that is not working;

FIG. 8 shows a flowchart illustrating specific steps in predicting the environmental state for the illustrative scenario of FIG. 7;

FIG. 9 shows a flow diagram showing the steps for determining an environmental state from raw data;

FIG. 10 shows a section of the flow diagram of FIG. 9 to illustrate the use of semantic reasoning to determine a test class; and

FIG. 11 shows an illustrative tree diagram that can be used in an alternate embodiment for determining a test class.

### DETAILED DESCRIPTION

The following description is merely exemplary in nature and is not intended to limit the present disclosure, its application or uses. It should be understood that throughout the drawings, corresponding reference numerals indicate like or corresponding parts and features.

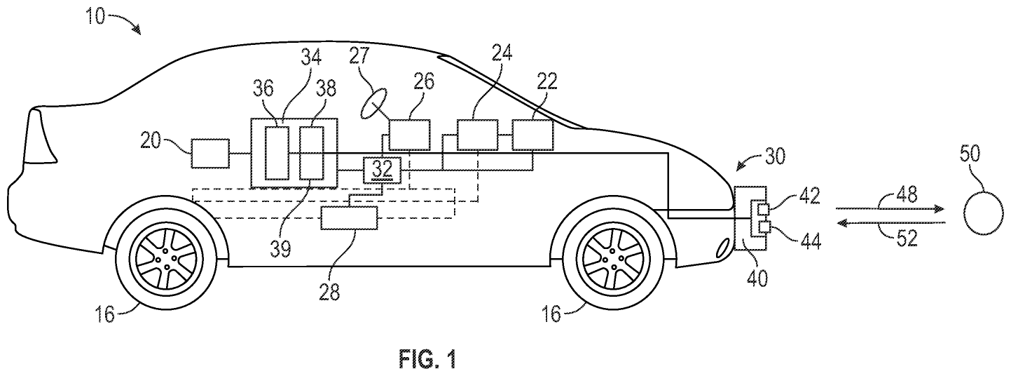

In accordance with an exemplary embodiment, FIG. 1 shows an autonomous vehicle 10. In an exemplary embodiment, the autonomous vehicle 10 is a so-called Level Four or Level Five automation system. A Level Four system indicates “high automation,” referring to the driving mode-specific performance by an automated driving system of all aspects of the dynamic driving task, even if a human driver does not respond appropriately to a request to intervene. A Level Five system indicates “full automation,” referring to the full-time performance by an automated driving system of all aspects of the dynamic driving task under all roadway and environmental conditions that can be managed by a human driver. It is to be understood that the system and methods disclosed herein can also be used with an autonomous vehicle operating at any of Levels One through Five.

The autonomous vehicle 10 generally includes at least a navigation system 20, a propulsion system 22, a transmission system 24, a steering system 26, a brake system 28, a sensor system 30, an actuator system 32, and a controller 34. The navigation system 20 determines a road-level route plan for automated driving of the autonomous vehicle 10. The propulsion system 22 provides power for creating a motive force for the autonomous vehicle 10 and can, in various embodiments, include an internal combustion engine, an electric machine such as a traction motor, and/or a fuel cell propulsion system. The transmission system 24 is configured to transmit power from the propulsion system 22 to two or more wheels 16 of the autonomous vehicle 10 according to selectable speed ratios. The steering system 26 influences a position of the two or more wheels 16. While depicted as including a steering wheel 27 for illustrative purposes, in some embodiments contemplated within the scope of the present disclosure, the steering system 26 may not include a steering wheel 27. The brake system 28 is configured to provide braking torque to the two or more wheels 16.

The sensor system 30 includes a radar system 40 that senses objects in an exterior environment of the autonomous vehicle 10 and determines various parameters of the objects useful in locating the position and relative velocities of various remote vehicles in the environment of the autonomous vehicle. Such parameters can be provided to the controller 34. In operation, the transmitter 42 of the radar system 40 sends out a radio frequency (RF) reference signal 48 that is reflected back at the autonomous vehicle 10 by one or more objects 50 in the field of view of the radar system 40 as one or more echo signals 52, which are received at receiver 44. The one or more echo signals 52 can be used to determine various parameters of the one or more objects 50, such as a range of the object, Doppler frequency or relative radial velocity of the object, and azimuth, etc. The sensor system 30 can include additional sensors such as digital cameras, Lidar, etc.

The controller 34 builds a trajectory or driving policy for the autonomous vehicle 10 based on the output of sensor system 30. The controller 34 can provide the trajectory or driving policy to the actuator system 32 to control the propulsion system 22, transmission system 24, steering system 26, and/or brake system 28 in order to move the autonomous vehicle 10 to follow the trajectory or according to the driving policy.

The controller 34 includes a processor 36 and a computer readable storage medium 38. The computer readable storage medium 38 includes programs or instructions 39 that, when executed by the processor 36, operate the autonomous vehicle 10 based on output from the sensor system 30. In various embodiment, the instructions 39 can cause the processor 36 to determine the behavior of road actors and predict a degraded environmental state based on the behavior of the road actors. Exemplary degraded environmental states can include, but are not limited to, a road condition, road construction, a traffic light malfunction, a stalled vehicle, an obstruction in the road, etc.

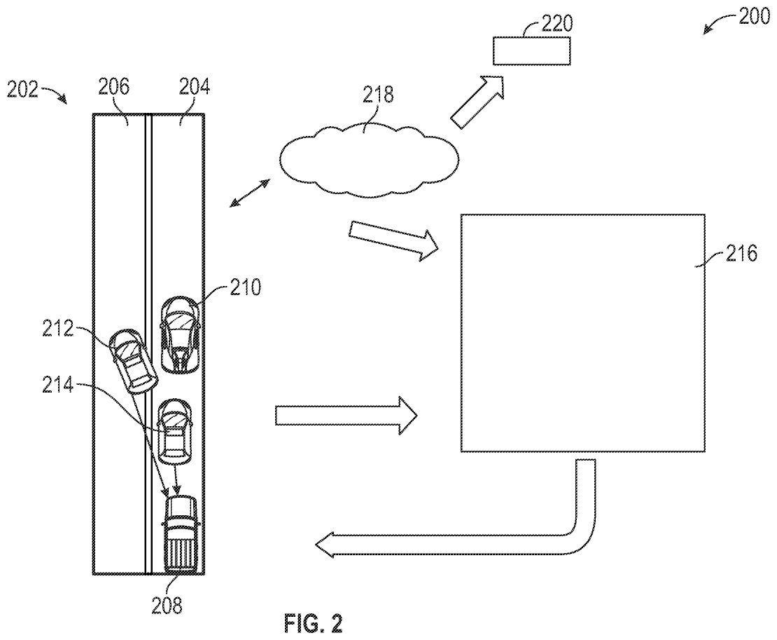

FIG. 2 is a diagram 200 illustrating a process by which the autonomous vehicle 10 can determine a degraded environmental state based on the behavior of other road actors. A road segment 202 is shown including a first lane 204 directing traffic in a first direction and a second lane 206 directing traffic in the opposite direction. An ego vehicle 208 is shown in the first lane 204. A stalled vehicle 210 is also in the first lane 204. The presence of the stalled vehicle 210 in the first lane 204 causes traffic to slow. Various road actors (such as road actors 212 and 214) are forced to move into the second lane 206 to get around the stalled vehicle 210. From its location in the first lane 204, the ego vehicle 208 is unable to detect the stalled vehicle 210. However, the ego vehicle 208 is able to detect raw data with respect to the road actors 212 and 214.

The raw data can be provided to a reasoning engine 216 operating on the processor 36. The reasoning engine 216 determines the current behavior of the road actors (e.g., road actors 212 and 214) from the raw data and predicts the environmental state from the road obstruction (i.e., the broken vehicle) detected from the behaviors of current road actors.

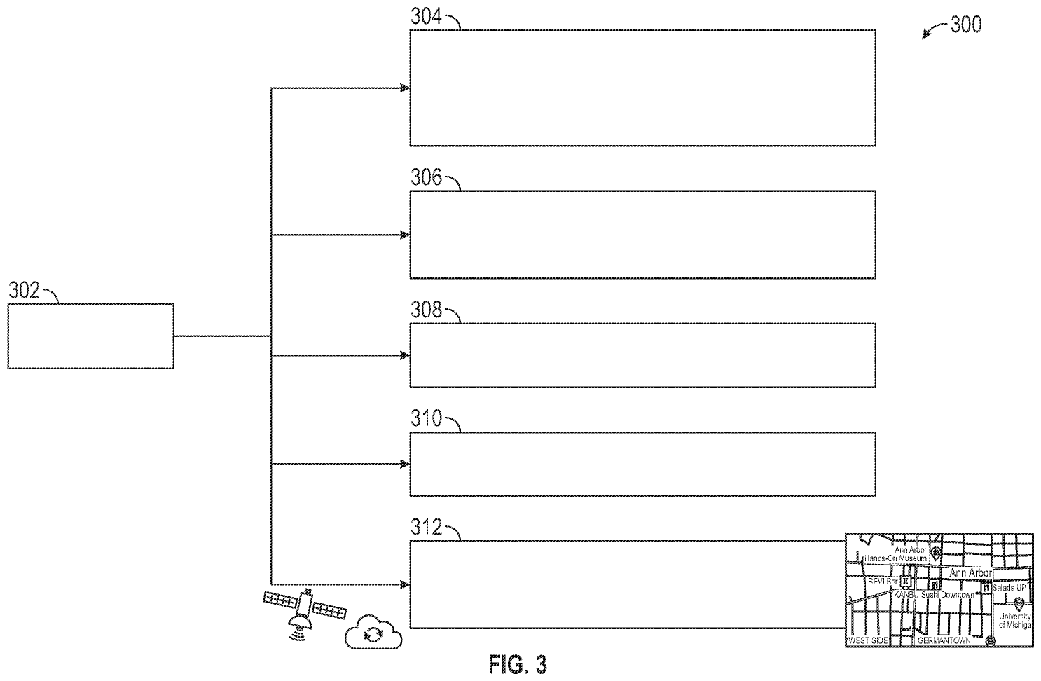

The reasoning engine 216 can be trained using data obtained when the environmental state is under normal conditions in order to determine an expected behavior of the road actors driving under degraded environmental conditions. The reasoning engine 216 can compare the current behavior of the road actors to the expected behavior. The reasoning engine 216 can be used to generate a model for vehicle behavior and identify a parameter of the model that is a characteristic of the expected behavior of the vehicle. A parameter of the current behavior of the road actors can also be determined. A difference in these two behaviors (or their corresponding parameter) can indicate the presence of a degraded environmental condition. The reasoning engine 216 can provide the degraded environmental condition to the navigation system 20 for planning a trajectory or driving policy for the ego vehicle 208. Additionally, or alternatively, the degraded environmental condition can be used at one or more downstream software modules, such as discussed with respect to FIG. 3.

FIG. 3 shows a schematic diagram 300 illustrating different applications for the detected road states. An environmental state detector 302 operates within the reasoning engine 216. The environmental state detector 302 outputs the detected degraded environmental condition. In a first application 304, a trajectory for the vehicle is designed that includes activating a driving policy based on the detected degraded environmental condition. In a second application 306, detected road states and vehicle behaviors are used to increase confidence in a decision made by the vehicle planning system. In a third application 308, mismatches are detected between prior knowledge of the road (such as mapping system information) and the current road condition based on detected road traffic behaviors. In a fourth application 310, a human machine interface can be used to notify the driver about the degraded environmental condition. In a fifth application 312 a map can be updated to include the state of the road or the degraded environmental condition. The first application 304, second application 306, third application 308, and fourth application 310 are generally applications suitable for short term planning, while the fifth application 312 is generally used in long term planning.

The reasoning engine 216 can also be in communication with a remote computer 218, such as a cloud computer, map server, etc. This remote computer 218 can provide map data or a normal expected behavior over a road segment, or other prior knowledge of the road segment. This information can be used in determining the presence of the degraded environmental state. In addition, once the environmental state is determined, this information can be shared back to the remote computer 218 and accessed by other vehicles 220.

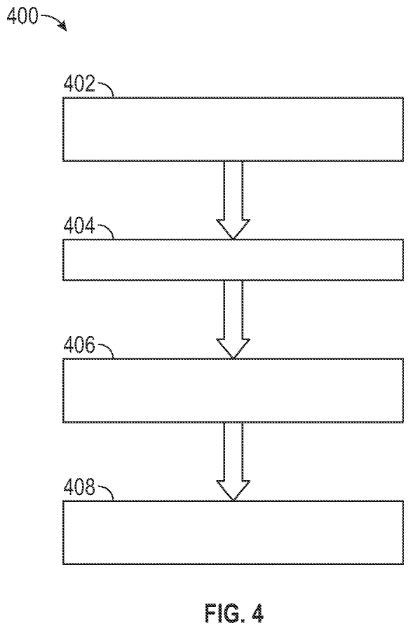

FIG. 4 shows a flowchart 400 of a method for predicting an environmental state from the behavior or road actions. In box 402, the perception and/or localization data is received, including raw data on the road actors and/or environmental objects, such as traffic lights, traffic signs, etc. In box 404, the raw data is preprocessed. In box 406, the behavior of the road actors is determined from the preprocessed data and the environmental state is predicted based on the behavior of the road actors. In box 408, the environmental state is used to plan a trajectory driving policy or behavior for the ego vehicle. The environmental state can also be provided to update local maps, prepare training data for the reasoning engine, etc.

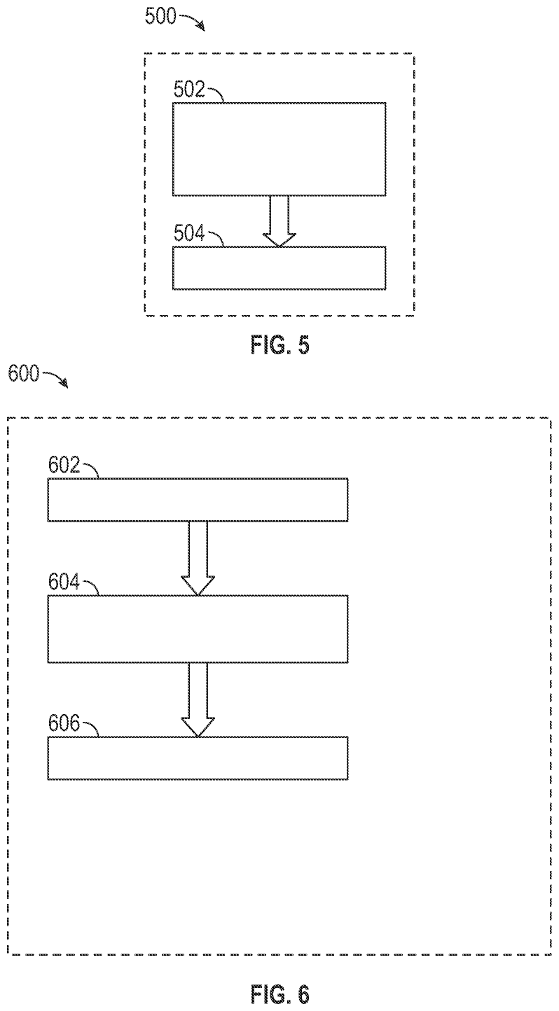

FIG. 5 shows a flowchart 500 illustrating the preprocessing steps of box 404 of FIG. 4. In box 502, spatial and temporal segmentation is performed on the raw perception data. In box 504, the segmented data is abstracted to label the road actors, traffic lights, etc. in the scene.

FIG. 6 shows a flowchart 600 illustrating the steps of box 406 of FIG. 4. In box 602, various features are extracted from the segmented data. The features include the actions being taken by the road actors present in the scene. Such actions can include but are not limited to deceleration, acceleration, stopping, starting, maintaining a constant speed, etc. The extracted features can also include information on various traffic signs or traffic lights in the scene. In box 604, multiple features of a road actor are arranged in a temporal or spatial sequence, which is then used to recognize a behavior of the vehicle. For example, a road actor that decelerates at an intersection, stops, waits and then accelerates through the intersection can be recognized as performing the behavior of stopping at a red light. In box 606, the behavior of the road actor is used to predict a road condition or environmental state (e.g., traffic light operational).

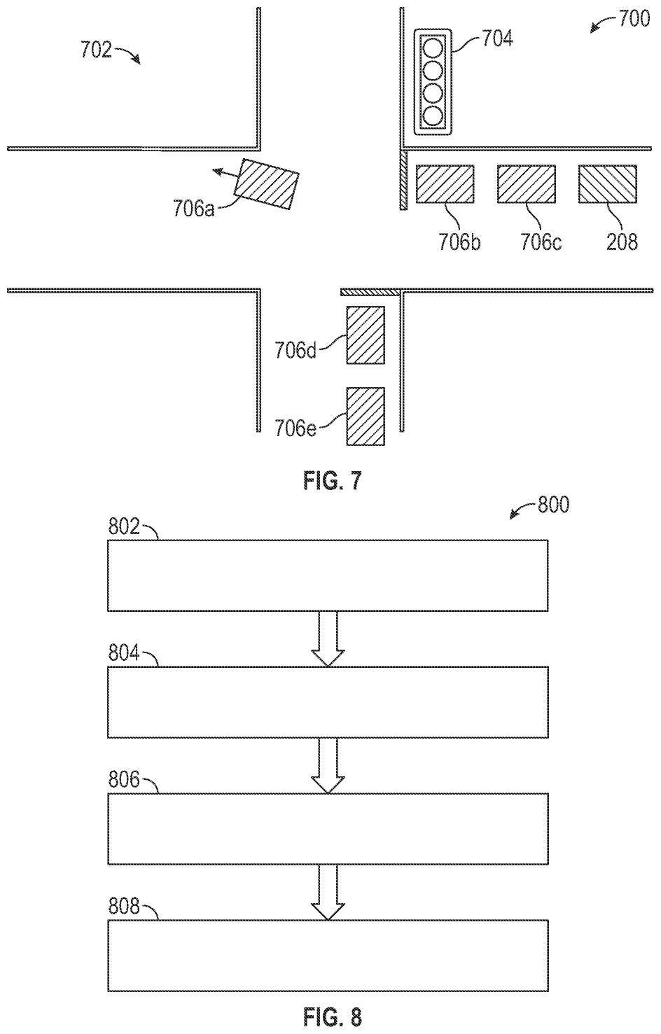

FIG. 7 is a diagram 700 of an illustrative scenario in which an intersection 702 includes a traffic light 704 that is not working. At its location far from the traffic light 704, the ego vehicle 208 may be unable to see that the traffic light is not working. The ego vehicle 208 is also unable to observe the traffic light operation for the lights facing the crossing road branches at the intersection. However, the ego vehicle 208 is able to obtain raw data that can be used to observe the behavior of the road actors 706a-706e. When the traffic light 704 is broken, the road actors 706a-706e will generally coordinate use of the intersection 702.

FIG. 8 shows a flowchart 800 illustrating specific steps in predicting the environmental state for the illustrative scenario of FIG. 7. In box 802, the features of the road actors are determined. These features can include, but are not limited stopping, decelerating, and accelerating by the road actor. Another feature can be the state of the traffic light (e.g., inactive traffic light). In box 804, the behavior of the road actor is determined from the features. As an example, one road actor decelerates, stops, accelerates, and then turns at the intersection. Another road actor decelerates, stops, accelerates, and crosses through the intersection. In box 806, the inoperative traffic light (also called traffic light in dark mode) is precited as the reason for the behaviors of the road actors. In box 808, the vehicle plans its driving policy, which includes stopping at the intersection and taking turns with other road actors in crossing through the intersection.

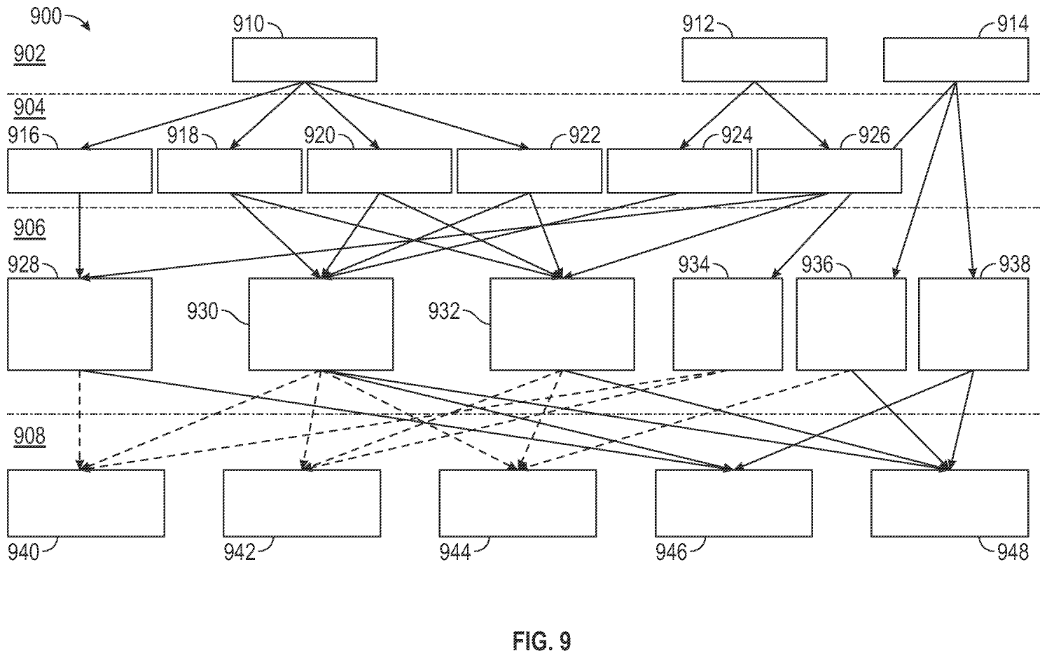

FIG. 9 shows a flow diagram 900 showing the steps for determining an environmental state from raw data. The diagram is separated into levels. The first level 902 includes raw data. The second level 904 includes feature extraction using raw data. The third level 906 includes detection of actors' behaviors. The fourth level 908 includes predicted environmental states, which can be in the form of training classes and/or test classes for the vehicle. The features of the second level 904 are derived from the raw data of the first level 902. The behaviors of the third level 906 are based on the features of the second level 904. The environmental states of the fourth level 908 are predicted based on the behaviors of the third level 906.

The raw data of the first level 902 includes data such as a road actor's speed 910, the road actor's position 912 and the presence of a road sign 914 (or traffic light).

The features of the second level 904 can include, for example, “cruising” 916 (maintaining a constant speed), “stopped” 918, “decelerating” 920, “accelerating” 922, which can be determined from the road actor's speed 910. The features can also be an indicator of the road actor being the lead vehicle (“lead vehicle” 924) or whether the road actor is crossing traffic (“crossing traffic” 926).

The detected behaviors at the third level 906 can include, for example, “the crossing traffic does not stop” 928, “the lead vehicle decelerates, stops and goes” 930, “the crossing traffic decelerates, stops and goes” 932. Attributes such as “inactive light” 934, “all-way stop sign” 936, and “stop sign” 938 also resides in this level can be determined from raw data of the road sign 914.

The estimated environmental states of the fourth level 908 can include “partially inactive traffic light” 940, “all-way inactive traffic light” 942, “missing an all-way stop sign” 944, “minor road-only stop control” 946 and “all-way stop” 948. The states of include “partially inactive traffic light” 940, “all-way inactive traffic light” 942, and “missing an all-way stop sign” 944 are due to weak signal communication for traffic control at the intersection, which are detected by the environmental state detector 302.

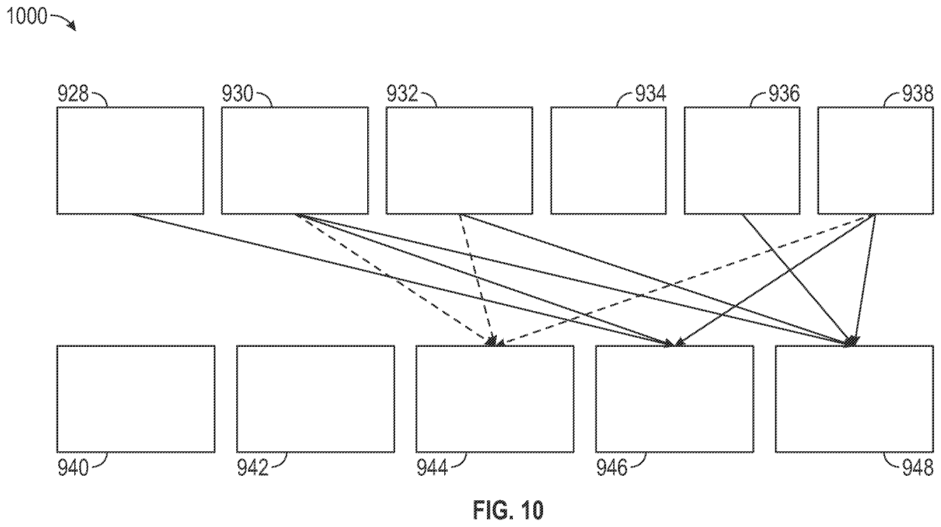

FIG. 10 shows a section 1000 of the flow diagram 900 of FIG. 9 to illustrate the use of semantic reasoning to determine a test class. The test class includes an intersection where the stop sign exists but the sign “ALL-WAY” is missing therefore, it is not clear if the crossing traffic will stop at this intersection or not. In an example, the behaviors of “the lead vehicle decelerates, stops and goes” 930 and “the crossing traffic decelerates, stops and goes” 932 are determined to be present at an intersection. Also, the feature of the intersection includes the “stop sign” 938. The intersection semantic state is detected to be a “missing an all-way stop sign” 944 from these features and from the determination of the resulting behaviors of the road actors.

In one embodiment, each feature can be assigned a probability and the reasons or conclusions predicted from the feature is a result of probabilistic calculations, which can include use of a Bayesian inferencing algorithm to update confidences or probabilities, for example.

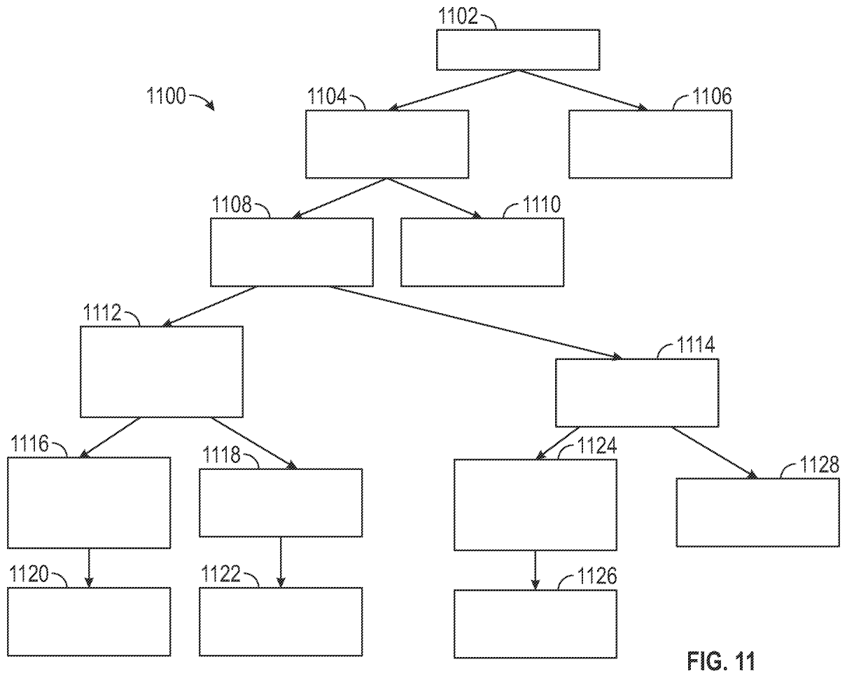

FIG. 11 shows an illustrative tree diagram 1100 that can be used in an alternate embodiment for determining a test class. A decision is at each node as to which branch to take in the next level of the tree diagram 1100. For illustrative tree diagram 1100, from raw signals, the reasoning engine 216 identifies an “intersection” node 1102. From the “intersection” node 1102, one branch leads to an “inactive traffic light” node 1104 while another branch leads to an “active light” node 1106. From the “inactive traffic light” node 1104, one branch leads to a “with lead vehicle” node 1108 while another branch leads to “without lead vehicle” node 1110. From the “with lead vehicle” node 1108, one branch leads to a “lead vehicle decelerates, stops and goes” node 1112 while another branch leads to an “lead vehicle cruises” node 1114. The “lead vehicle decelerates, stops and goes” node 1112 leads to a “crossing traffic decelerates, stops and goes” node 1116 while another branch leads to an “opposite traffic cruises” node 1118. The “crossing traffic decelerates, stops and goes” node 116 leads to the conclusion of an “all-way inactive traffic light” environmental state 1120. The “opposite traffic cruises” node 1118 leads to the conclusion of an “partially inactive traffic light” environmental state 1122.

Returning to the “lead vehicle cruises” node 1114, a first branch leads to a “crossing traffic decelerates, stops and goes” node 1124, which allows for the conclusion of “a minor road only stop control” environmental state 1126. Another branch from the “lead vehicle cruises” node 1114 leads to a “crossing traffic cruises” node 1128.

The determined environmental state can be used for to improve various aspects of the driving process. Once the environmental state is determined a trajectory or driving policy can be generated and used to move and navigate the vehicle. Alternatively, the environmental state can be used to increase a confidence of the vehicle in a trajectory that has already been generated. Mismatches can be detected between the prior mapping information for the vehicle and a new mapping necessitated by the degraded environmental conditions. Also, the driver can be notified of the detected situation. The environmental state can be used to update map system information, which is shared with other vehicles, thereby improving the quality of data provided with the other vehicles and facilitate trajectory planning at these other vehicles.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method of operating a vehicle, comprising:
detecting a current behavior of a road actor in response to an environmental state;
determining the environmental state based on the current behavior of the road actor;
planning a driving policy for the vehicle based on the environmental state; and
actuating a movement of the vehicle according to the driving policy.

2. The method of claim 1, wherein the environmental state further comprises at least one of: (i) an unknown road condition; (ii) road construction; (iii) a traffic signal malfunction; (iv) a stalled vehicle; (v) an obstruction in the road; (vi) a weakly controlled or uncontrolled road intersection; and (vii) a newly changed road condition.

3. The method of claim 1, further comprising obtaining raw data of the road actor, determining a feature for the road actor from the raw data, and determining the current behavior from the feature.

4. The method of claim 3, wherein the feature of the road actor is at least one of: (i) a deceleration; (ii) an acceleration; (iii) a stopped motion; (iv) an initiated motion; (v) a deviation from a lane; and (vi) a turn maneuver.

5. The method of claim 3, further comprising determining the behavior from a location of the feature within at least one of a temporal and a spatial sequence.

6. The method of claim 1, further comprising determining the environmental state using at least one of: (i) a Bayesian inference algorithm; and (ii) a tree diagram.

7. The method of claim 1, further comprising creating a model for vehicle behavior, identifying a parameter of the model for an expected behavior of the road actor under a normal environmental state, and detecting a difference between the current behavior and the expected behavior to determine the environmental state from a comparison of the parameter of the model to the parameter for the current behavior.

8. A system for navigating an autonomous vehicle, comprising:
a sensor configured to obtain raw data of a road actor in an environment; and
a processor configured to:
determine a current behavior of the road actor from the raw data, wherein the current behavior is in response to an environmental state;
determine the environmental state based on the current behavior of the road actor;
plan a driving policy for the vehicle based on the environmental state; and
actuate a movement of the vehicle according to the driving policy.

9. The system of claim 8, wherein the environmental state further comprises at least one of: (i) a road condition; (ii) road construction; (iii) a traffic signal malfunction; (iv) a stalled vehicle; (v) an obstruction in the road; (vi) a weakly controlled or uncontrolled road intersection; and (vii) a newly changed road condition.

10. The system of claim 8, wherein the processor is further configured to determine a feature for the road actor from the raw data and determine the current behavior from the feature.

11. The system of claim 10, wherein the feature of the road actor is at least one of: (i) a deceleration; (ii) an acceleration; (iii) a stopped motion; (iv) an initiated motion; (v) a deviation from a lane; and (vi) a turn maneuver.

12. The system of claim 10, wherein the processor is further configured to determine the behavior from a location of the feature within at least one of a temporal and a spatial sequence.

13. The system of claim 8, wherein the processor is further configured to determine the environmental state using at least one of: (i) a Bayesian inference algorithm; and (ii) a tree diagram.

14. The system of claim 8, wherein the processor is further configured to create a model for vehicle behavior, identify a parameter of the model for an expected behavior of the road actor under a normal environmental state, and detect a difference between the current behavior and the expected behavior to determine the environmental state from a comparison of the parameter of the model to the parameter for the current behavior.

15. A vehicle, comprising:
a sensor configured to obtain raw data of a road actor in an environment; and
a processor configured to:
determine a current behavior of the road actor from the raw data, wherein the current behavior is in response to an environmental state;
determine the environmental state based on the current behavior of the road actor;
plan a driving policy for the vehicle based on the environmental state; and
actuate a movement of the vehicle according to the driving policy.

16. The vehicle of claim 15, wherein the environmental state further comprises at least one of: (i) a road condition; (ii) road construction; (iii) a traffic signal malfunction; (iv) a stalled vehicle; (v) an obstruction in the road; (vi) a weakly controlled or uncontrolled road intersection; and (vii) a newly changed road condition.

17. The vehicle of claim 15, wherein the processor is further configured to determine a feature for the road actor from the raw data and determine the current behavior from the feature.

18. The vehicle of claim 17, wherein the processor is further configured to determine the behavior from a location of the feature within at least one of a temporal sequence and a spatial sequence.

19. The vehicle of claim 15, wherein the processor is further configured to determine the environmental state using at least one of: (i) a Bayesian inference algorithm; and (ii) a tree diagram.

20. The vehicle of claim 15, wherein the processor is further configured to create a model for vehicle behavior, identify a parameter of the model for an expected behavior of the road actor under a normal environmental state, and detect a difference between the current behavior and the expected behavior to determine the environmental state from a comparison of the parameter of the model to the parameter for the current behavior.
